(19) United States
(12) Patent Application Publication
(10) Pub. No.: US 2014/0104823 A1
(43) Pub. Date: Apr. 17, 2014

(54) REFLECTOR ADDITION TO FLUORESCENT LUMINAIRES

(71) Applicant: Antonios Paravantsos, Thessaloniki (GR)

(72) Inventor: Antonios Paravantsos, Thessaloniki (GR)

(21) Appl. No.: 14/054,730

(22) Filed: Oct. 15, 2013

(30) Foreign Application Priority Data
Oct. 15, 2012 (GR) 20120100522

(51) Int. Cl. F21V 7/00

(52) U.S. Cl. CPC F21V 7/005
USPC 362/217.05

(57) ABSTRACT

An elongated reflector for increasing the lumen output of an installed, elongated luminaire and for mounting onto the luminaire without requiring use of a tool is disclosed. The installed luminaire includes a shell with a pair of elongated lateral sides having outwardly facing portions with outwardly facing protrusions. The elongated reflector comprises first and second longitudinal ends. Each end has a respective mounting component with a pair of cooperating shafts resiliently biased towards the pair of elongated lateral sides when the reflector is mounted onto the luminaire. Each shaft has a respective nib at an end of the shaft. Each nib reaches round and gripping an upper side of one of the protrusions when the reflector is mounted to the luminaire.

### FIELD OF THE INVENTION

The present invention relates to reflectors for focusing and directing light from already installed fluorescent luminaires for the purpose of increasing the lumen output of the installed luminaires.

### BACKGROUND OF THE INVENTION

The issue of electrical energy waste continues to exist in millions of lighting installations all over the planet, which consist of old fluorescent luminaires, which, during manufacture, does not include a reflector that would increase energy efficiency. The amounts of electrical energy wasted through the uselessly diffused light of current lighting installations are notably large. However, the costs of replacing the luminaires in these old lighting installations have significant costs, which are discouraging for building owners or users.

In regard to these older lighting installations, since the past decade, an effort has been made by specialists to find ways to modify already-installed luminaires in order to improve their lumen output. One very important modification was the addition of a reflector to already installed luminaires. The installation of reflectors required some mode of mounting and fastening the reflector onto the luminaire. The most usual method is to fasten the reflector onto the body of the luminaire with bolts. This method requires at least one intervention onto the already installed luminaire, to allow for opening of some holes for the fixing bolts; one disadvantage of this approach is that it entails removing the cover of the luminaire and making modifications to it so that it can receive other means of fastening the reflector. This work can only be carried out by a specialized electrician and it is labor-intensive, leading to increased labor costs that dissuade building owners from proceeding to undertake the upgrading of their luminaires.

One class of fluorescent luminaires consists of the lengthwise or linear fluorescent luminaires, also known as “batten fittings.” They consist of a lengthwise base, on the inside of which electrical parts are found and the wiring for the luminaire, and a lengthwise cover that is placed over the open end of the base, so that the entire fitting is closed off and the interior with the fitting's electrical parts is inaccessible. At the two ends of the luminaire are the lamp holders which hold the tubular fluorescent lamps, usually one or two.

In the foregoing class of luminaires, a large amount of the light emitted by the fluorescent lamps is diffused toward the ceiling, or generally toward the upper part of the room. Especially in high-ceilinged buildings, which may be over four meters high, this diffused light does not offer any lumen benefit to the people using the illuminated spaces, while the part of the electrical energy consumed by the luminaire to produce this amount of light is essentially a useless expense for the user of the light installation.

For this reason, the lengthwise fluorescent luminaires that are now being manufactured are already equipped, before installation, with some type of appropriate reflector, which focuses the amount of light that would otherwise have been diffused toward the ceiling and subsequently directs it toward the desired levels of visual use of the space. In this manner, the lumen output of the luminaire increases. Hence, any given lighting installation can include luminaires with improved lumen output that consume less electrical energy, or fewer luminaires may be installed, with the obvious result of significant energy efficiency and savings.

The lengthwise or linear or “boat”-type fluorescent luminaires with one or two tubular fluorescent lamps constitute a very prevalent type of lighting fittings used for the illumination of office buildings, which are usually also high-ceilinged buildings. The amount of electrical energy wasted through the uselessly diffused light of these lighting installations is notably large. On the other hand, replacing the luminaires in these old lighting installations has a significant cost, which in most cases is dissuading for the building owners or users. This cost includes the purchase of new luminaires, the dismantling of the old fittings, and the labor costs to install the new ones.

Other methods of fastening the reflector onto already installed luminaires have been implemented, for example, by attaching the reflector onto the tubular fluorescent lamps, or onto the body of the fluorescent luminaire using magnets or adhesive tape. However, these mounting methods are not acceptable either by European or by American regulations, nor are they accepted by the international Electro-technical Laboratories that certify the proper function and safety of luminaires.

It would be desirable if the installation of the reflector onto the shell of already installed lengthwise fluorescent luminaires with one or two lamps does not require either a specialized installer electrician or the use of any specific tool.

It would also be desirable if the installation did not require the modification or processing of the installed luminaire, nor any alteration of its condition. This makes attaching the reflector onto already installed lengthwise fluorescent luminaires very fast and easy. Hence, the labor cost for installing the reflector on the already installed luminaire is greatly reduced, rendering the upgrading of existing light installations financially viable and economical, since the investment is redeemed over a short period of time.

### SUMMARY OF THE INVENTION

One embodiment of the invention provides for a reflector for a fluorescent luminaire with one or two tubular lamps, which can be fitted onto already installed fluorescent luminaires without the use of tools and without requiring any processing or alteration of the already installed luminaire. The reflector is attached to the luminaire by the flexible shafts of the reflector's mounting components, which grip onto the protrusions of the shell of a fluorescent luminaire, in order to hold the reflector onto the fluorescent lighting fixture.

The reflector bears on either end mounting components. These mounting components have flexible shafts which, due to their suppleness and flexibility, can be bent outward and grip onto protrusions of the shell of the fluorescent luminaire. On the ends of the flexible shafts are nibs which can be positioned around the protrusions of the shell of the fluorescent luminaire and grip onto the protrusions, so as to keep the reflector attached to the fluorescent luminaire. In this manner, the entire reflector remains fixed onto the already installed fluorescent luminaire, without requiring any previous technical intervention or alteration of the fluorescent luminaire. Furthermore, the installation of the reflector onto the shell of the fluorescent luminaire does not require the use of any tool, such as a screwdriver or drill, and can be implemented by an unskilled worker, not necessarily a specialized installer electrician.

By way of example, the present invention provides an elongated reflector for increasing the lumen output of an installed, elongated luminaire and for mounting onto the luminaire without requiring use of a tool. The installed luminaire includes a shell with a pair of elongated lateral sides having outwardly facing portions with outwardly facing protrusions. The elongated reflector comprises first and second longitudinal ends. Each end has a respective mounting component with a pair of cooperating shafts resiliently biased towards the pair of elongated lateral sides when the reflector is mounted onto the luminaire. Each shaft has a respective nib at an end of the shaft. Each nib reaches round and gripping an upper side of one of the protrusions when the reflector is mounted to the luminaire.

Beneficially, installation of the foregoing, elongated reflector does not require either a specialized installer electrician or the use of any specific tool. Additionally, in a preferred form, the foregoing reflector does not require the modification or processing of the installed luminaire, nor any alteration of its condition.

### BRIEF DESCRIPTION OF THE DRAWINGS

Further features and advantages of the invention will become apparent from reading the following detailed description in conjunction with the following drawings, in which like reference numbers refer to like parts:

FIG. 1 is a perspective view of an inventive reflector system from one end of a reflector.

FIG. 2 is an exemplary perspective view of an inventive reflector assembled onto a luminaire from one end of the luminaire.

FIG. 3 is a detail, perspective view of an inventive reflector assembled onto a luminaire from one end of the luminaire.

### DETAILED DESCRIPTION OF THE INVENTION

The examples and drawings provided in the detailed description are merely examples, and should not be used to limit the scope of the claims in any claim construction or interpretation.

One object of the invention, as described, is the creation of a reflector that can be adjusted onto the shell of already installed lengthwise fluorescent luminaires with one or two lamps, without requiring the use of a tool for the placement of the reflector, and without requiring any processing or alteration of the state of the already installed fluorescent luminaires. Furthermore, the claimed reflector does not rest on or even touch the fluorescent lamps of the fluorescent luminaires. This is achieved by fastening certain parts of the reflector directly onto the shell of the fluorescent luminaire. In one example, the reflector's parts have spring-like shafts that can be opened outward by hand in order to surround the body of the luminaire, then the spring-like shafts grip onto the protrusions of the luminaire, or around the bottom of its shell.

In one example, the reflector 1 bears on either end mounting components 2. These mounting components 2 include flexible shafts 3, which, due to their flexibility, can be bent outward and grip onto protrusions 6 of the shell 5 of the fluorescent luminaire 4.

On the ends of the flexible shafts 3, there are nibs 7 that go around the protrusions 6 of the shell 5 of the fluorescent luminaire 4 and grip onto the protrusions, so as to keep the reflector 1 attached to the fluorescent luminaire 4 The nibs allow for secure fixing of the reflector onto the luminaire and thus do not allow the reflector to be detached or to fail off from the luminaire. In this manner, the entire reflector 1 remains fixed onto the already installed fluorescent luminaire 4, without requiring any previous technical intervention or alteration of the fluorescent luminaire 4. Furthermore, the installation of the reflector 1 onto the shell 5 of the fluorescent luminaire 4 does not require the use of any tool, such as a screwdriver or a drill, and can be implemented by an unskilled worker, not necessarily a specialized installer electrician.

In one example, the shafts can be made of polycarbonate plastic material. The shafts are highly flexible to a degree which allows for the nibs to pass behind the luminaire's protrusions which serve as fixing points.

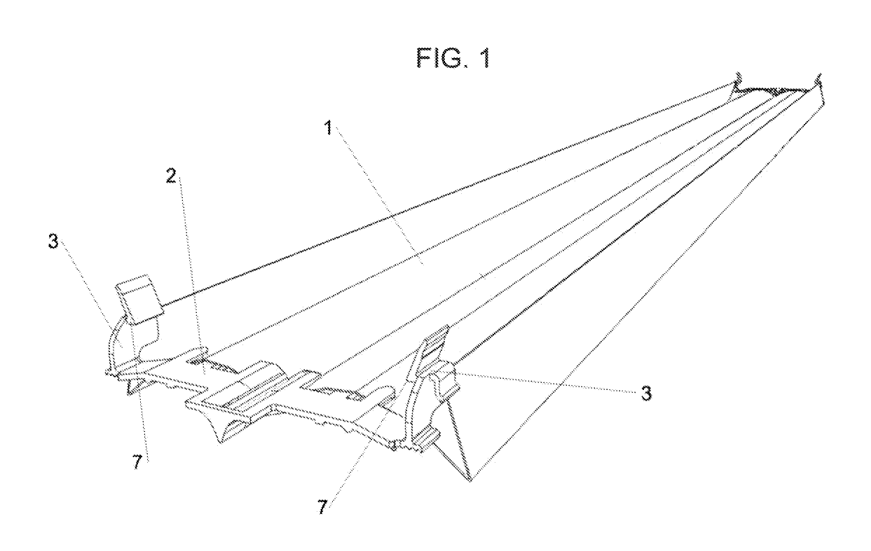

In FIG. 1, a reflector 1 with its mounting component 2 at one end of the reflector. At either end of the mounting component, the mounting component 2 has flexible shafts 3 which contain nibs 7 which go around the protrusions of the shell of luminaire (not depicted).

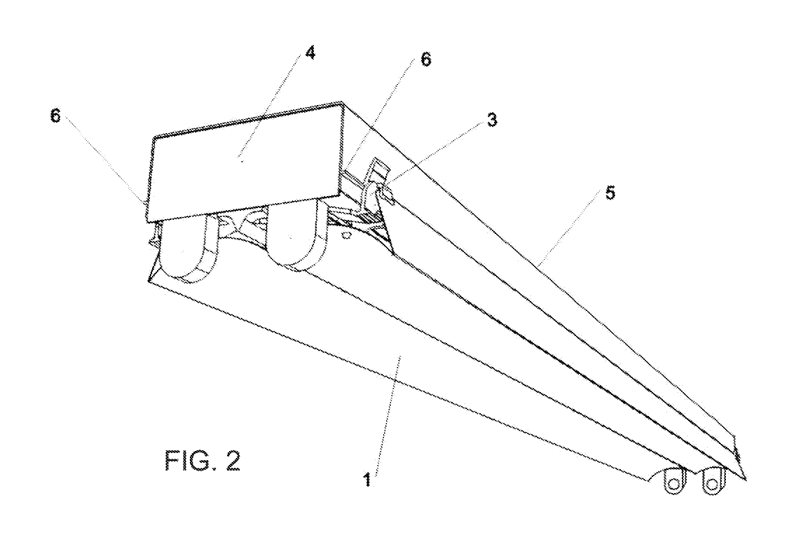

in FIG. 2, a reflector 1 is installed onto a fluorescent luminaire 4. Flexible shafts 3 of the mounting component, which, due to their flexibility, are able to grip onto the protrusions 6 of the shell 5 of the fluorescent luminaire 4. The reflector 1 attaches onto the shell 5 of the fluorescent luminaire 4.

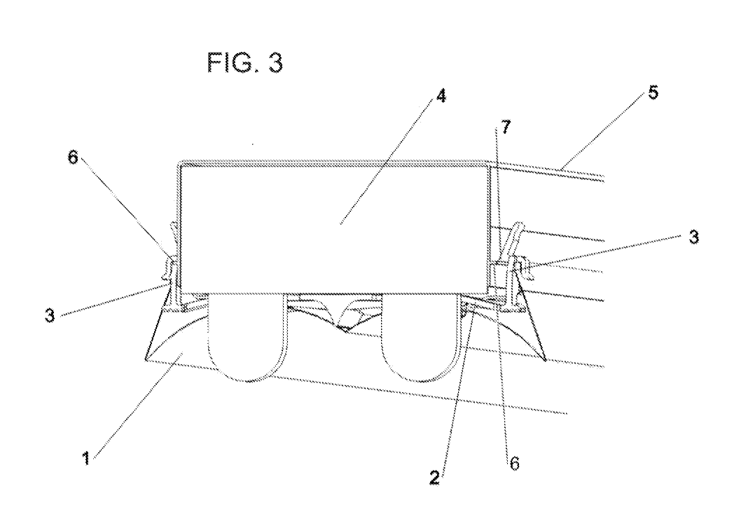

In FIG. 3, a reflector 1 is mounted onto a fluorescent luminaire 4 through its mounting components 2 which have flexible shafts 3 that include nibs 7 which are positioned around the protrusions 6 of the shell 5 of the fluorescent luminaire 4.

The following is a list of reference numerals and associated parts as used in this specification and drawings:

| Reference Numeral | Part |
|---|---|
| 1 | Reflector |
| 2 | Mounting components |
| 3 | Flexible shafts |
| 4 | Fluorescent luminaire |
| 5 | Shell of fluorescent luminaire |
| 6 | Protrusions of shell |
| 7 | Nibs of flexible shaft |

The scope of the claims should not be limited by the preferred embodiments and examples, but should be given the broadest interpretation consistent with the written description as a whole.

What is claimed is:

1. An elongated reflector for increasing the lumen output of an installed, elongated luminaire and for mounting onto the luminaire without requiring use of a tool; the installed luminaire including a shell with a pair of elongated lateral sides having outwardly facing portions with outwardly facing protrusions, the elongated reflector comprising:
a) first and second longitudinal ends; each end having a respective mounting component with a pair of cooperating shafts resiliently biased towards said pair of elongated lateral sides when the reflector is mounted onto said luminaire; and
b) each shaft having a respective nib at an end of the shaft; each nib reaching around and gripping an upper side of one of said protrusions when the reflector is mounted to the luminaire.

2. The reflector of claim 1, wherein each shaft grips onto a respective portion of the shell other than said protrusion when the reflector is mounted to the luminaire.

3. The reflector of claim 1, wherein each shaft grips onto a respective protrusion portion of the shell when the reflector is mounted to the luminaire.

4. The reflector of claim 1, wherein the cooperating shafts are so constructed that they can be pulled apart by hand in order to allow each associated nib of said corresponding shafts to reach around and grip an upper side of one of said protrusions when the reflector is mounted to the luminaire.
